(19) United States
(12) Patent Application Publication
(10) Pub. No.: US 2026/0290736 A1
(43) Pub. Date: Sep. 24, 2026

(54) PREPARATION METHOD OF TUNGSTEN-RHENIUM-BASED DIFFUSION-TYPE THERMIONIC CATHODE MATERIAL CONTAINING LOW MELTING POINT BARIUM CALCIUM ALUMINATE SALT

(71) Applicant: Beijing University of Technology, Beijing (CN)

(72) Inventors: Jinshu Wang, Beijing (CN); Zhenghui Zheng, Beijing (CN); Zichen Li, Beijing (CN); Yongfeng Cai, Beijing (CN); Yunfei Yang, Beijing (CN); Chen Lai, Beijing (CN); Ying Wang, Beijing (CN); Xixi Hu, Beijing (CN)

(21) Appl. No.: 19/082,534

(22) Filed: Mar. 18, 2025

(51) Int. Cl. H01J 9/04; H01J 1/144

(52) U.S. Cl. CPC H01J 9/047; H01J 1/144

(57) ABSTRACT

A preparation method of tungsten-rhenium-based diffusion-type thermionic cathode material containing low melting point barium calcium aluminate salt is provided, which relates to the field of preparation technologies of electron emission cathode materials. In the tungsten-rhenium-based diffusion-type thermionic cathode material prepared by combining freeze-drying and heat treatment, tungsten and rhenium elements are distributed evenly, and only a single phase exists in W—Re alloy powder after heat treatment. In impregnation salt, introduction of fluoride increases generation of active substances such as Ba in the impregnation material to a certain extent, which enhances emission capability of the cathode. Based on the prepared single-phase tungsten-rhenium-base and low melting point barium calcium aluminate salt, an emission current density of the prepared single-phase tungsten-rhenium-based diffusion-type cathode containing low melting point barium calcium aluminate salt is 13.5 A/cm², which has excellent thermal emission performance.

### TECHNICAL FIELD

The disclosure relates to the field of preparation technologies of electron emission cathode materials, and more particularly to a preparation method of a tungsten-rhenium-based diffusion-type thermionic cathode material containing low melting point barium calcium aluminate salt.

### BACKGROUND

Thermionic cathode is an electron emission source, which heats the cathode material and applies a low electric field on the cathode material, to increase the energy of disordered thermal motion of electrons inside the cathode material, and overcome surface potential barriers, and produce directional transitions into vacuum, and the thermionic cathode is currently the most widely used cathode. Therefore, the thermionic cathode is a core of vacuum electronic devices, and its stability directly affects the performance of the vacuum electronic devices. At present, the most outstanding and widely used thermionic cathodes include barium tungsten (Ba—W) cathodes, M-type cathodes, and scandium (Sc) containing diffusion cathodes. Among them, the traditional Ba—W cathodes have a relatively low emission current density (100 amperes per square centimeter abbreviated as A/cm²), which is insufficient for the use requirement of high-power vacuum electronic devices. Although the M-type cathodes have a higher emission current density (101 A/cm²), they still have many defects in overall performance. The Sc containing diffusion cathodes such as Sc-based cathodes have the highest emission current density, but they are difficult to be widely used in national defense and aerospace fields because of its low ion bombardment resistance and poor thermionic emission recovery ability.

Tungsten-rhenium-base cathode material is a promising cathode in the M-type cathodes. Although the tungsten-rhenium-based cathode materials have developed rapidly since their invention, in previous studies, they were generally prepared by mechanical mixing method. Although this method is efficient, the poor uniformity of raw material powder mixing and rhenium powder agglomeration make it difficult to obtain single-phase tungsten-rhenium-based cathodes in subsequent sintering, processing and other processes, resulting in the appearance of brittle tungsten rhenium (W₂Re₃) phase rich in rhenium (Re), reducing the structural stability of tungsten-rhenium-based cathode and ultimately affecting its overall performance.

In addition, during preparing the cathode, impregnation materials need to be impregnated into the cathode base. The impregnation materials are a class of multi-component oxides including elements such as barium (Ba), strontium (Sr), calcium (Ca), aluminum (Al), and Sc, their main functions are to reduce the work function of the thermionic cathode surface and to generate active substances (such as Ba—O dipoles or Ba elemental) during thermal excitation. The most widely used impregnation material currently is the multi-component oxide in the barium calcium aluminate (BaO·CaO·Al₂O₃) system. The typical impregnation material, known as 411 salts (i.e., the barium calcium aluminate), has a melting point of 1450 Celsius degrees (° C.) to 1550° C., and the corresponding impregnation temperature for the thermionic cathode is 1600° C. to 1700° C. The multi-component oxide not only requires a high calcination temperature for preparation, but also has a high melting point, which is not conducive to the subsequent impregnation process and leads to energy waste.

### SUMMARY

In view of this, an objective of the disclosure is to provide a preparation method of a tungsten-rhenium-based diffusion-type thermionic cathode material containing low melting point barium calcium aluminate salt.

In order to achieve the above objective, the disclosure provides the following technical solutions.

In one of the technical solutions of the disclosure, a preparation method of a tungsten-rhenium (W—Re)-based diffusion-type thermionic cathode material containing low melting point barium calcium aluminate salt is provided, including:
step 1, dissolving ammonium paratungstate and ammonium perrhenate in water to obtain a W—Re precursor solution;
step 2, freeze-drying the W—Re precursor solution to obtain W—Re alloy powder;
step 3, performing multi-step hydrogen reduction heat treatment on the W—Re alloy powder, followed by pressing to obtain a cathode body;
step 4, sintering the cathode body to obtain a cathode base;
step 5, mixing a barium containing compound, a calcium containing compound, an aluminum containing compound and a sintering aid evenly to obtain a mixture, and performing a mechanical mixing method, a hydrothermal method or a co-precipitation method on the mixture to obtain an impregnation salt precursor;
step 6, drying the impregnation salt precursor, followed by pressing, calcining, and grinding to obtain an impregnation material;
step 7, embedding the cathode base in the impregnation material, performing a sintering impregnation process on the impregnation material embedded with the cathode base under a hydrogen atmosphere, followed by annealing to obtain the W—Re-based diffusion-type thermionic cathode material containing low melting point barium calcium aluminate salt.

In the second technical solution of the disclosure, a W—Re-based diffusion-type thermionic cathode material containing low melting point barium calcium aluminate salt is provided, which is prepared by the aforementioned preparation method.

The disclosure discloses the following technical effects.

In the W—Re-based diffusion-type thermionic cathode material prepared by combining the freeze-drying and the heat treatment in the disclosure, the tungsten and rhenium elements are distributed evenly, and only a single phase exists in the W—Re alloy powder after heat treatment. In the impregnation salt, the introduction of fluoride increases the generation of active substances such as Ba in the impregnation material to a certain extent, which enhances the emission capability of the cathode. The disclosure is based on the prepared single-phase W—Re-base and low melting point barium calcium aluminate salt. The thermal electron emission performance of the W—Re-based diffusion-type cathode prepared by combining the above two methods is tested. It is found that the single-phase W—Re-based diffusion-type cathode containing low melting point barium calcium aluminate salt has excellent thermal electron emission performance, with an emission current density of 13.5 A/cm² at 1100° C., and has great application prospects in the thermionic cathodes.

### BRIEF DESCRIPTION OF DRAWINGS

In order to describe technical solutions in the disclosure or the related art clearly, drawings required in embodiments will be simply introduced below. Apparently, the drawings in the following descriptions are merely some of the embodiments of the disclosure. For those skilled in the art, other drawings can be obtained according to these drawings without creative work.

FIG. 1A illustrates an X-ray diffraction (XRD) graph of W—Re alloy powder after hydrogen reduction but without heat treatment (i.e., the reduction parameters are set as follows: holding at 340° C. for 2 h, followed by holding at 755° C. for 2 h, and holding at 1050° C. for 2 h) in step (3) according to an embodiment 1 of the disclosure.

FIG. 1B illustrates an XRD graph of W—Re alloy powder after hydrogen reduction and heat treatment (i.e., the reduction parameters are set as follows: holding at 340° C. for 2 h, followed by holding at 755° C. for 2 h, holding at 1050° C. for 2 h, and holding at 1400° C. for 2 h) in the step (3) according to the embodiment 1 of the disclosure.

FIG. 2A illustrates an XRD graph of an impregnation material prepared by adding sintering aid barium fluoride according to the embodiment 1 of the disclosure.

FIG. 2B illustrates a differential scanning calorimetry (DSC) curve diagram of the impregnation material prepared by adding the sintering aid barium fluoride according to the embodiment 1 of the disclosure.

FIG. 3 illustrates an energy dispersive spectrogram (EDS) of the impregnation material prepared by calcining in step (6) according to the embodiment 1 of the disclosure.

FIG. 4 illustrates a schematic diagram of cathode emission curves of a W—Re-based diffusion-type thermionic cathode material containing low melting point barium calcium aluminate salt prepared in the embodiment 1 and a traditional Ba—W cathode containing 612 salts.

### DETAILED DESCRIPTION OF EMBODIMENTS

Various exemplary embodiments of the disclosure are now described in detail, which should not be construed as limiting the disclosure, but rather as a more detailed description of certain aspects, features, and embodiments of the disclosure.

It should be understood that the terms used in the disclosure are merely for describing specific embodiments and are not intended to limit the disclosure. In addition, the numerical range in the disclosure should be understood that each intermediate value between the upper and lower limits of the range is also specifically disclosed. Any intermediate value within any stated value or range, as well as any smaller range between any other stated value or intermediate value within the range, are also included in the disclosure. These smaller upper and lower limits can be independently included or excluded within the range.

Unless otherwise specified, all technical and scientific terms used in this article have the same meanings as those commonly understood by those skilled in the art of the disclosure. Although the disclosure only describes some methods and materials, any methods and materials similar or equivalent to those described herein may also be used in the implementation or testing of the disclosure. All references mentioned in the specification are incorporated by reference to disclose and describe methods and/or materials related to the mentioned references. In case of conflict with any incorporated literature, the content of the specification shall prevail.

Various improvements and variations can be made to the specific embodiments of the disclosure without departing from the scope or spirit of the disclosure, which will be apparent to those skilled in the art. Other embodiments obtained from the specification of the disclosure will be apparent to those skilled in the art. The specification and embodiments of the disclosure are merely exemplary.

The terms “including”, “comprising”, “having” and “containing” used in this article are all open-ended terms, meaning they include but are not limited to.

Aiming at a problem of poor mixing uniformity of raw material powder in the current preparation process of W—Re-based cathode materials, powder alloying is one of the effective methods to solve the uniformity of W—Re alloy microstructure. Freeze-drying is a drying method that the solution is pre-frozen and the frozen solution is placed in vacuum state to directly sublime ice in the freeze-dried sample. The powder dried by the method has good uniformity, a process that is easy to industrialize, and fewer impurities. The dried powder can maintain original physicochemical properties, which becomes the effective method to achieve powder uniform in recent years. The disclosure combines the freeze-drying method with heat treatment process to prepare single-phase W—Re-based thermionic cathode base materials in-situ. Meanwhile, the disclosure innovatively introduces the sintering aid into the traditional barium calcium aluminate salt, and calcines and grinds the solid phase to obtain an impregnation material for thermionic cathode with low melting point. Finally, the disclosure combines the single-phase W—Re-based thermionic cathode base materials and the impregnation material to obtain the tungsten-rhenium-based diffusion-type thermionic cathode material containing low melting point barium calcium aluminate salt. The material has excellent thermionic cathode emission performance, which provides a new idea for developing a new thermionic cathode material.

In the first aspect, the disclosure provides a preparation method of a W—Re-based diffusion-type thermionic cathode material containing low melting point barium calcium aluminate salt, including the following steps 1-7.

In step 1, ammonium paratungstate and ammonium perrhenate are dissolved in water to obtain a W—Re precursor solution.

In step 2, the W—Re precursor solution is freeze-dried to obtain W—Re alloy powder.

In step 3, multi-step hydrogen reduction heat treatment is performed on the W—Re alloy powder, followed by pressing to obtain a cathode body.

In step 4, the cathode body is sintered to obtain a cathode base.

In step 5, a barium containing compound, a calcium containing compound, an aluminum containing compound and a sintering aid are mixed evenly to obtain a mixture, and a mechanical mixing method, a hydrothermal method or a co-precipitation method are performed on the mixture to obtain an impregnation salt precursor.

In step 6, the impregnation salt precursor is dried, followed by pressing, calcining, and grinding to obtain an impregnation material.

In step 7, the cathode base is embedded in the impregnation material, a sintering impregnation process is performed on the impregnation material embedded with the cathode base under a hydrogen atmosphere, followed by annealing to obtain the tungsten-rhenium-based diffusion-type thermionic cathode material containing low melting point barium calcium aluminate salt.

In some embodiments of the disclosure, a dosage of the ammonium paratungstate and the ammonium perrhenate is that rhenium accounts for 15% to 26% of a mass of the W—Re alloy powder.

In some embodiments of the disclosure, parameters of the freeze-drying are set as follows: a pressure of the freeze-drying is less than 50 pascals (Pa), and a period of the freeze-drying is greater than or equal to 36 hours (h).

In some embodiments of the disclosure, parameters of the multi-step hydrogen reduction heat treatment are set as follows: a first step is at a temperature of 300° C. to 500° C. for 0.5 h to 3 h, a second step is at a temperature of 700° C. to 850° C. for 0.5 h to 3 h, a third step is at a temperature of 1000° C. to 1100° C. for 0.5 h to 3 h, and a fourth step is at a temperature of 1300° C. to 1500° C. for 0.5 h to 3 h. A hydrogen flow rate during the multi-step hydrogen reduction heat treatment is 0.5 liters per minute (L/min) to 1 L/min.

In the disclosure, when the multi-step hydrogen reduction heat treatment is adjusted to one or two-step hydrogen reduction heat treatment, it will make it difficult to achieve powder alloying of W—Re alloys near the solubility limit of rhenium, resulting in rhenium element segregation.

In the disclosure, the W—Re alloy powder after multi-step hydrogen reduction heat treatment is pressed to obtain the cathode body, and the cathode body has certain porosity and mechanical strength.

In some embodiments of the disclosure, the sintering includes first low-temperature sintering followed by high-temperature sintering. The low-temperature sintering comprises holding at 750° C. to 950° C. for 20 minutes (min), followed by holding at 1050° C. to 1150° C. for 20 min. The high-temperature sintering comprises holding at 1400° C. to 1600° C. for 20 min.

In the disclosure, in the obtained cathode base, a content of rhenium is 15 weight percent (wt. %) to 26 wt. %. The obtained phase is a single phase and is a W phase, and Re is completely dissolved in the tungsten base.

In some embodiments of the disclosure, the barium containing compound is barium hydroxide octahydrate (Ba(OH)₂·8H₂O) or barium nitrate (Ba(NO₃)₂). The calcium containing compound is calcium hydroxide (Ca(OH)₂) or calcium nitrate (Ca(NO₃)₂). The aluminum containing compound is aluminum hydroxide (Al(OH)₃) or aluminum nitrate (Al(NO₃)₃). The sintering aid comprises barium fluoride (BaF₂), calcium fluoride (CaF₂), aluminum fluoride (AlF₃), strontium fluoride (SrF₂), scandium fluoride (ScF₃) or boron fluoride (B₂O₃). Ratios of the barium containing compound, the calcium containing compound, the aluminum containing compound and the sintering aid as raw materials follow the following principles: a molar ratio between Ba and Ca in the raw material is 3:1 to 5:1, a molar ratio between Ba and Al in the raw material is 3:1 to 5:1, and the sintering aid accounts for 0.01% to 0.4% of a total mass of the barium containing compound, the calcium containing compound, the aluminum containing compound and the sintering aid.

The specific preparation means of the mechanical mixing method, the hydrothermal method and the co-precipitation method are not particularly limited in the disclosure, and conventional technical means of those skilled in the art can be selected. When the co-precipitation method is used for preparation, the chosen precipitant is ammonium carbonate.

In some embodiments of the disclosure, when drying the impregnation salt precursor, the method for the drying is freeze-drying or heat-drying. A temperature of the freeze-drying may be smaller than or equal to −75° C., and a period of the freeze-drying may be greater than or equal to 12 h. A temperature of the heat-drying may be in a range of 110° C. to 130° C., and a period of the heat-drying may be 30 h.

In some embodiments of the disclosure, when drying the impregnation salt precursor, and followed by pressing, a pressure of the pressing is in a range of 1 megapascal (MPa) to 3 MPa, and a pressure holding time is in a range of 20 seconds(s) to 60 s (for example, 30 s).

In some embodiments of the disclosure, the calcining is performed under an inert atmosphere. A temperature of the calcining is in a range of 1200° C. to 1500° C., and a holding time of the calcining is in a range of 0.5 h to 2 h (for example, 0.5 h).

In some embodiments of the disclosure, the sintering impregnation process specifically includes: first heating to a temperature of 1400° C. to 1600° C., then heating to a temperature of 1650° C. to 1680° C. within 1 min to 2 min, holding at the temperature of 1650° C. to 1680° C. for 1 min to 2 min, subsequently cooling to 1500° C. within 1 min, and finally cooling to room temperature with a furnace.

In some embodiments of the disclosure, after the sintering impregnation process, the preparation method further includes washing and drying.

In some embodiments of the disclosure, a temperature of the annealing is 1050° C., and a holding time of the annealing is 30 min.

In the second aspect, the disclosure provides a W—Re-based diffusion-type thermionic cathode material containing low melting point barium calcium aluminate salt prepared by the aforementioned preparation method.

Unless otherwise specified, the technical solution described in the disclosure is a conventional solution in this field, and all the reagents or raw materials used are purchased from commercial channels or have been disclosed.

In order to better understand the disclosure, the contents of the disclosure will be further clarified with embodiments below, but the contents of the disclosure are not limited to the following embodiments.

### Embodiment 1

(1) 3.216 grams (g) of ammonium paratungstate is dissolved in 37.6 milliliters (mL) of deionized water to obtain an ammonium paratungstate solution. 0.864 g of ammonium perrhenate is dissolved in 75 mL of deionized water to obtain an ammonium perrhenate solution. A magnetic stirrer with a rotational speed of 300 revolutions per minute (rpm) is used to stir the ammonium paratungstate solution and the ammonium perrhenate solution until it is clear without precipitation. Then, the ammonium paratungstate solution and the ammonium perrhenate solution are mixed to obtain a W—Re precursor solution. A content of Re in the W—Re precursor solution is 20 wt. %.

(2) The W—Re precursor solution is poured in a polytetrafluoroethylene (PTFE) beaker, the PTFE beaker with the W—Re precursor solution is placed in a culture dish, and 1 liter (L) of liquid nitrogen is immediately poured outside the culture dish to freeze the W—Re precursor solution, to thereby obtain a W—Re frozen body. A cold well valve of a freeze dryer is opened in advance, when a temperature of the cold well is reduced to −83° C., the W—Re frozen body is placed in a drying bin of the freeze dryer. A vacuum valve of the freeze dryer is opened to make a pressure in the drying bin lower than 50 Pa, and the W—Re frozen body is dried for 36 h. After the W—Re frozen body is completely dried, take out it to obtain W—Re alloy powder.

(3) The W—Re alloy powder is placed into a tube furnace to perform multi-step hydrogen reduction heat treatment to obtain single-phase W—Re alloy powder. Specifically, the multi-step hydrogen reduction heat treatment includes: the first step of holding at 340° C. for 2 h, the second step of holding at 755° C. for 2 h, the third step of holding at 1050° C. for 2 h, and the fourth step of holding at 1400° C. for 2 h; and the atmosphere inside the furnace is hydrogen gas, with a flow rate of 1 L/min. 0.13 g of the single-phase W—Re alloy powder obtained by the multi-step hydrogen reduction heat treatment is weighed and placed in a mold with a mold cavity diameter of 3 millimeters (mm), an oil press is used to apply a pressure of 0.75 Pa to the single-phase W—Re alloy powder in the mold and maintain it for 30 s, to obtain a cathode body with certain porosity and mechanical strength.

(4) The cathode body is placed in a W mesh hydrogen furnace and is sintered under a hydrogen atmosphere with sintering parameters of 850° C. for 20 min, 1100° C. for 20 min and 1500° C. for 20 min, and then cooled with the furnace to obtain the single-phase W—Re thermionic cathode base.

(5) A one ten-thousandth analytical balance is used to weigh 18.4556 g of barium hydroxide octahydrate, 1.1114 g of calcium hydroxide, 2.34 g of aluminum hydroxide and 0.2504 g of barium fluoride, and they are placed in an agate mortar to be ground for 10 min to obtain a mixture. The mixture is placed in a PTFE lining, and proper amount of deionized water is added into the PTFE lining with the mixture, and then the PTFE lining with the mixture and the deionized water is stirred evenly. Specifically, solid and liquid account 70% of a total space of the PTFE lining. The PTFE lining with the solid and the liquid is placed in a high-pressure digestion kettle, and the high-pressure digestion kettle is heated at 140° C. for 24 h in a homogeneous reaction device at a speed of 30 rpm. After the hydrothermal reaction is completed, a suspension in the PTFE lining is poured in a PTFE beaker. The suspension is frozen to a solid through a liquid nitrogen extremely cold process. The frozen solid phase mixture is placed in the freeze dryer that has been cooled to −80° C. for 48 h of low-temperature vacuum drying. After thorough drying, take out it without further processing to obtain an impregnation material precursor for thermionic cathode containing sintering aid.

(6) 4 g of the impregnation material precursor is taken out and pressed in the mold to obtain a cylindrical precursor. A pressure for the pressed is 2 MPa, and a pressure holding time is 30 s. The cylindrical precursor is placed in a vertical high-temperature tube furnace under a nitrogen (99.99%) atmosphere and calcined at 1400° C. for 0.5 h to obtain a calcined precursor. After the calcining is completed, the calcined precursor is cooled and ground to obtain an impregnation material for thermionic cathode with low melting point.

(7) The single-phase W—Re thermionic cathode base obtained in the step (4) is embedded into the impregnation material obtained in the step (6), and the impregnation material embedded with the single-phase W—Re thermionic cathode base is placed in the W mesh hydrogen furnace for high-temperature impregnation under a hydrogen atmosphere. The process parameters for the high-temperature impregnation are set as follows: first heat to 1500° C., then heat to 1680° C. within 2 min, hold at 1680° C. for 2 min, subsequently cool to 1500° C. within 1 min, and finally cool to the room temperature with the furnace before taking out it. The obtained cathode after impregnating is placed in the deionized water, and washed in an ultrasonic cleaning machine. During washing, a surface of the cathode is continuously observed until the presence of active salts is no longer visible under a microscope. The washed cathode is soaked in alcohol for dehydration to obtain a dehydrated cathode. The dehydrated cathode is placed in a drying oven and dried at 80° C. to obtain a dried cathode. The dried cathode is taken out and annealed. The temperature of the annealing is 1050° C., with a holding time of 30 min, thereby obtaining the tungsten-rhenium-based diffusion-type thermionic cathode material containing low melting point barium calcium aluminate salt.

### Comparative Embodiment 1

The only difference from the embodiment 1 is that the addition of barium fluoride is omitted, and its steps and parameters are the same as those in the embodiment 1.

### Effect Verification Embodiment

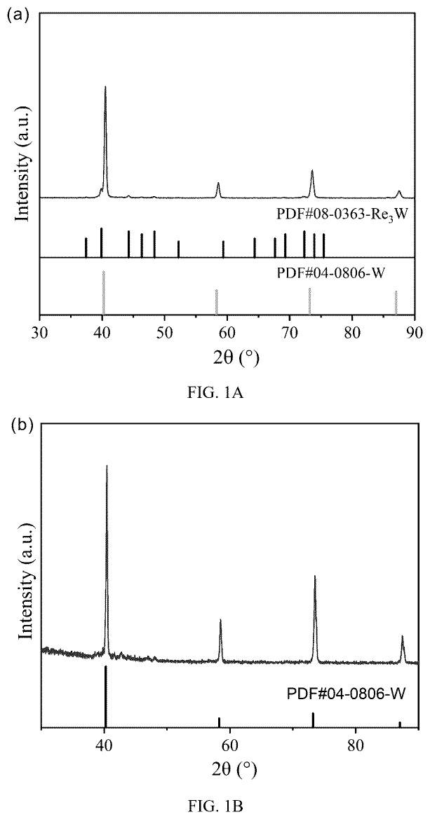

An XRD graph of the W—Re alloy powder after the hydrogen reduction but without heat treatment (i.e., the reduction parameters are set as follows: holding at 340° C. for 2 h, followed by holding at 755° C. for 2 h, and holding at 1050° C. for 2 h) in the step (3) of the embodiment 1 is shown in FIG. 1A. It can be seen that the W—Re powder after freeze-drying and hydrogen reduction exists rhenium tungsten (Re₃W) phase, which is a brittle phase, and may deteriorate the cathode performance. An XRD graph of the W—Re alloy powder after the hydrogen reduction and heat treatment (i.e., the reduction parameters are set as follows: holding at 340° C. for 2 h, followed by holding at 755° C. for 2 h, holding at 1050° C. for 2 h, and holding at 1400° C. for 2 h) in the step (3) of the embodiment 1 is shown in FIG. 1B. It can be seen that the powder after heat treatment only exists the W phase, which indicates that Re is completely dissolved in the W base.

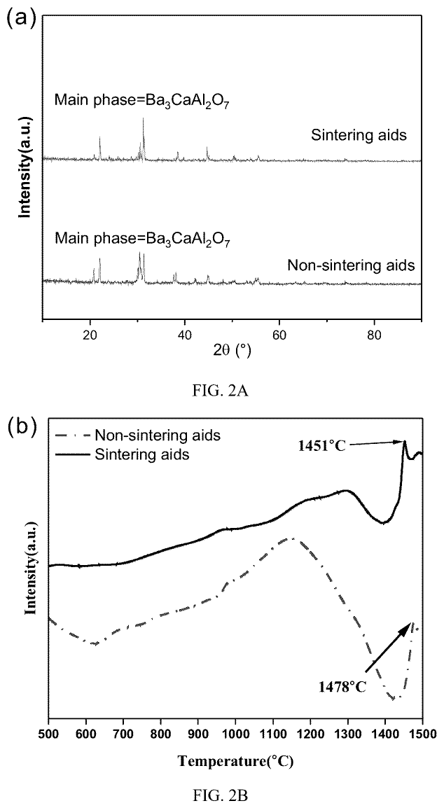

FIG. 2A indicates that the impregnation material (i.e., the product obtained in the step (6)) prepared by adding sintering aid barium fluoride in the embodiment 1 has better crystallinity and no obvious impurities appear. The DSC curves in FIG. 2B indicates that the melting point of the impregnation material (i.e., the product obtained in the step (6)) prepared by adding sintering aid barium fluoride in the embodiment 1 is 1451° C., which is 27° C. lower than the 1478° C. without the sintering aid (the comparative embodiment 1).

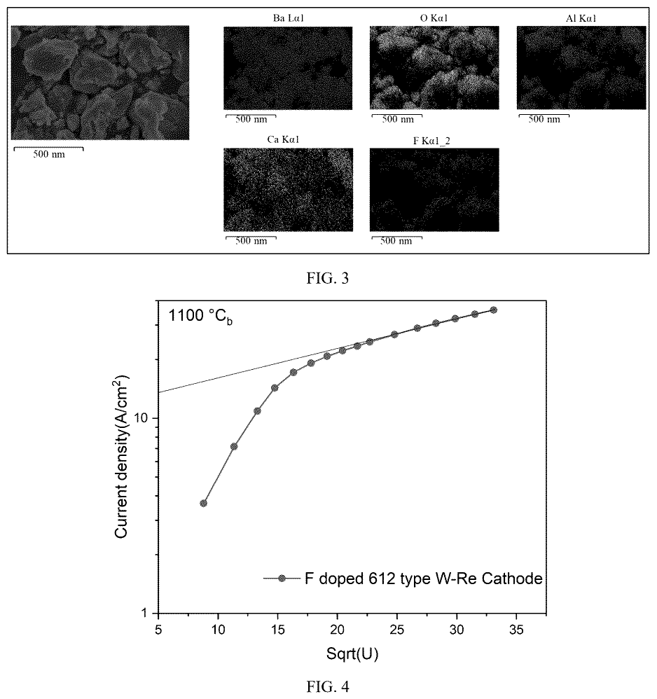

FIG. 3 indicates that the element distribution of the impregnation material after calcining in the step (6) of the embodiment 1 is uniform.

FIG. 4 (in FIG. 4, F doped 612 type W—Re cathode represents the W—Re-based diffusion-type thermionic cathode material containing low melting point barium calcium aluminate salt prepared in the embodiment 1) indicates that an emission current density of the W—Re-based diffusion-type thermionic cathode material containing low melting point barium calcium aluminate salt prepared in the embodiment 1 is 13.5 A/cm². The W—Re-based diffusion-type thermionic cathode material prepared by the disclosure has higher emission current density, which has great application prospects in the thermionic cathodes.

The above is merely some of the embodiments of the disclosure. It should be pointed out that for those skilled in the art, multiple improvements and embellishments can be made without departing from the principles of the disclosure, and these improvements and embellishments should also be considered as the scope of protection of the disclosure.

What is claimed is:

1. A preparation method of a tungsten-rhenium (W—Re)-based diffusion-type cathode material containing barium calcium aluminate salt, comprising:
step 1, dissolving ammonium paratungstate and ammonium perrhenate in water to obtain a W—Re precursor solution;
step 2, freeze-drying the W—Re precursor solution to obtain W—Re alloy powder;
step 3, performing multi-step hydrogen reduction heat treatment on the W—Re alloy powder, followed by pressing to obtain a cathode body;
step 4, sintering the cathode body to obtain a cathode base;
step 5, mixing a barium containing compound, a calcium containing compound, an aluminum containing compound and a sintering aid evenly to obtain a mixture, and performing a mechanical mixing method, a hydrothermal method or a co-precipitation method on the mixture to obtain an impregnation salt precursor;
step 6, drying the impregnation salt precursor, followed by pressing, calcining, and grinding to obtain an impregnation material; and
step 7, embedding the cathode base in the impregnation material, performing a sintering impregnation process on the impregnation material embedded with the cathode base under a hydrogen atmosphere, followed by annealing to obtain the W—Re-based diffusion-type cathode material containing barium calcium aluminate salt.

2. The preparation method of the W—Re-based diffusion-type cathode material containing barium calcium aluminate salt as claimed in claim 1, wherein a dosage of the ammonium paratungstate and the ammonium perrhenate is that rhenium accounts for 15% to 26% of a mass of the W—Re alloy powder.

3. The preparation method of the W—Re-based diffusion-type cathode material containing barium calcium aluminate salt as claimed in claim 1, wherein parameters of the freeze-drying are set as follows: a pressure of the freeze-drying is less than 50 pascals (Pa), and a period of the freeze-drying is greater than or equal to 36 hours (h).

4. The preparation method of the W—Re-based diffusion-type cathode material containing barium calcium aluminate salt as claimed in claim 1, wherein parameters of the multi-step hydrogen reduction heat treatment are set as follows: a first step is at a temperature of 300 Celsius degrees (° C.) to 500° C. for 0.5 h to 3 h, a second step is at a temperature of 700° C. to 850° C. for 0.5 h to 3 h, a third step is at a temperature of 1000° C. to 1100° C. for 0.5 h to 3 h, and a fourth step is at a temperature of 1300° C. to 1500° C. for 0.5 h to 3 h; and a hydrogen flow rate during the multi-step hydrogen reduction heat treatment is 0.5 liters per minute (L/min) to 1 L/min.

5. The preparation method of the W—Re-based diffusion-type cathode material containing barium calcium aluminate salt as claimed in claim 1, wherein the sintering comprises first low-temperature sintering followed by high-temperature sintering; the low-temperature sintering comprises holding at 750° C. to 950° C. for 20 minutes (min), followed by holding at 1050° C. to 1150° C. for 20 min; and the high-temperature sintering comprises holding at 1400° C. to 1600° C. for 20 min.

6. The preparation method of the W—Re-based diffusion-type cathode material containing barium calcium aluminate salt as claimed in claim 1, wherein the barium containing compound is barium hydroxide octahydrate (Ba(OH)₂·8H₂O) or barium nitrate (Ba(NO₃)₂); the calcium containing compound is calcium hydroxide (Ca(OH)₂) or calcium nitrate (Ca(NO₃)₂); the aluminum containing compound is aluminum hydroxide (Al(OH)₃) or aluminum nitrate (Al(NO₃)₃); and the sintering aid comprises barium fluoride (BaF₂), calcium fluoride (CaF₂), aluminum fluoride (AlF₃), strontium fluoride (SrF₂), scandium fluoride (ScF₃) or boron fluoride (B₂O₃);
ratios of the barium containing compound, the calcium containing compound, the aluminum containing compound and the sintering aid as raw materials follow the following principles: a molar ratio between barium (Ba) and calcium (Ca) in the raw materials is 3:1 to 5:1, a molar ratio between Ba and aluminum (Al) in the raw materials is 3:1 to 5:1, and the sintering aid accounts for 0.01% to 0.4% of a total mass of the barium containing compound, the calcium containing compound, the aluminum containing compound and the sintering aid.

7. The preparation method of the W—Re-based diffusion-type cathode material containing barium calcium aluminate salt as claimed in claim 1, wherein the calcining is performed under an inert atmosphere; a temperature of the calcining is in a range of 1200° C. to 1500° C., and a holding time of the calcining is in a range of 0.5 h to 2 h.

8. The preparation method of the W—Re-based diffusion-type cathode material containing barium calcium aluminate salt as claimed in claim 1, wherein the sintering impregnation process specifically comprise: first heating to a temperature of 1400° C. to 1600° C., then heating to a temperature of 1650° C. to 1680° C. within 1 min to 2 min, holding at the temperature of 1650° C. to 1680° C. for 1 min to 2 min, subsequently cooling to 1500° C. within 1 min, and finally cooling to room temperature with a furnace.

9. The preparation method of the W—Re-based diffusion-type cathode material containing barium calcium aluminate salt as claimed in claim 1, wherein a temperature of the annealing is 1050° C., and a holding time of the annealing is 30 min.

10. A tungsten-rhenium-based diffusion-type cathode material containing barium calcium aluminate salt, wherein the tungsten-rhenium-based diffusion-type cathode material containing barium calcium aluminate salt is prepared by the preparation method as claimed in claim 1.
